(19) United States
(12) Patent Application Publication
(10) Pub. No.: US 2021/0191388 A1
(43) Pub. Date: Jun. 24, 2021

(54) DEVICE AND METHOD FOR CONTROLLING A HIGHLY AUTOMATED VEHICLE

(71) Applicant: Robert Bosch GmbH, Stuttgart (DE)

(72) Inventors: Martin Marquart, Reichenbach (DE); Florian Haag, Ellhofen (DE); Nikolas Loeffelmann, Heilbronn (DE)

(21) Appl. No.: 17/119,286

(22) Filed: Dec. 11, 2020

(30) Foreign Application Priority Data
Dec. 19, 2019 (DE) 102019220142.3

(51) Int. Cl. G05D 1/00; B60W 60/00; B60W 40/08; B60W 50/14; G01P 15/00; G01P 13/00

(52) U.S. Cl. CPC G05D 1/0016; B60W 60/0015; B60W 40/08; B60W 2556/45; G05D 1/0022; G01P 15/00; G01P 13/00; B60W 50/14

(57) ABSTRACT

A device and to a method for controlling a highly automated vehicle, as well as a portable unit for remotely controlling the highly automated vehicle, the highly automated vehicle being able to independently carry out driving maneuvers without the intervention of the driver or a vehicle occupant. The device for controlling is connected to the portable unit. The device for controlling receives a signal from the portable unit that the portable unit has detected a dropping by the vehicle driver or a vehicle occupant. Upon detection of a free fall, the presently independently carried out driving maneuver is automatically aborted or terminated.

### CROSS REFERENCE

The present application claims the benefit under 35 U.S.C. § 119 of German Patent Application No. DE 102019220142.3 filed on Dec. 19, 2019, which is expressly incorporated herein by reference in its entirety.

### FIELD

The present invention relates to a device and to a method, each for controlling a highly automated vehicle, as well as a portable unit for remotely controlling a highly automated vehicle, the automated vehicle being able to independently carry out driving maneuvers without the intervention of the driver or a vehicle occupant, and the device for controlling being connected to the portable unit, and the device for controlling receiving a signal from the portable unit that the portable unit has detected being dropped by the vehicle driver or a vehicle occupant, and upon detection of a free fall, the instantaneously independently carried out driving maneuver being automatically aborted or terminated.

### BACKGROUND INFORMATION

A system and a method for controlling the movement of an automatic parking device, which includes a drive for the movement of a pallet accommodating the vehicle to be parked, are described in German Patent Application No. DE 10 2015 117 591 A1. A control unit is provided for the drive. An access code is output at an output, and an input code is entered at a mobile control device. The input code is wirelessly transmitted to the control unit, and the control unit only releases a movement of the pallet when the input code corresponds to the access code. As a result, a system is described in which a control unit and a mobile control device are wirelessly linked to one another, and which is able to remotely control the control unit, which moves a unit accommodating the vehicle, with the aid of the mobile control device.

### SUMMARY

A main feature of the present invention is to control a driving maneuver, which is carried out independently or at least largely independently by a highly automated vehicle, by means of a remote control and, in the event of a loss of the remote control, for example due to the remote control being accidentally dropped, to be able to safely terminate or to be able to safely abort the driving maneuver. This furthermore provides the option of aborting or terminating the driving maneuver within a very short time by the vehicle driver or one of the vehicle occupants by intentionally dropping the remote control to end hazardous situations preferably quickly.

According to the present invention, this is achieved by the features of example embodiments. Advantageous refinements and embodiments are described herein.

Advantageously, in accordance with an example embodiment of the present invention, it is provided that the connection between the device for controlling the highly automated vehicle and the portable unit is a wireless connection, in particular a radio link having a short range. This connection is also implementable using a hard-wired connection; however, today's devices frequently offer antennas and adapters for WLAN- or Bluetooth-based radio links, so that these short-range connections may advantageously be used for implementing the connection according to the present invention.

In accordance with the present invention, it is furthermore advantageous that the portable unit is a smart phone or a tablet computer. The portable unit may also be a remote control provided specifically for this purpose, which was developed and designed for this specific application.

Today, cell phones, in particular cell phones having an extensive computer functionality, are known and very widely used under the name “smart phone,” so that it lends itself to implement the portable unit in the form of a smart phone, on which only a corresponding application, also referred to as an “app,′” has to be installed. In the process, the term “smart phone” is to be interpreted very broadly, so that it includes not only cell phones, but also tablet computers or any other type of so-called hand-held device that may be used. Furthermore, it is possible that a vehicle key may be expanded with radio remote control for locking and unlocking the vehicle in such a way that it includes operating elements for remotely controlling the vehicle, and may thus be used as a portable unit within the scope of the present invention.

It is furthermore advantageous in accordance with an example embodiment of the present invention that the portable unit is designed as a remote control for controlling the driving maneuvers of the highly automated vehicle. In the process, the remote control may mean that the driver or another vehicle occupant or a person in the immediate vehicle surroundings may use the portable unit for predefining the longitudinal vehicle movement, i.e., driving forward and driving backward, or the lateral vehicle movement, i.e., the steering angle to the left or the steering angle to the right. As an alternative or in combination, it is furthermore possible to predefine or to influence both the longitudinal vehicle movement and the lateral vehicle movement in combination.

In accordance with an example embodiment of the present invention, it is furthermore advantageous that the operator of the remote control does not have to separately enter or predefine the longitudinal and/or lateral vehicle movements, but that the portable unit offers one or multiple driving maneuver(s) to choose from, and the operator of the remote control selects a suitable driving maneuver. This may, for example, take place in such a way that the vehicle driving in a highly automated manner has detected a free parking spot, and the vehicle now proposes to park the vehicle in parallel to the driving direction or perpendicularly to the vehicle direction. The operator of the remote control may select from these two driving maneuvers, and the highly automated vehicle independently carries out this selected driving maneuver. In this embodiment, it is particularly important that the operator of the remote control, in the form of the portable unit, is able to terminate or abort the driving maneuver at any time and quickly in hazardous situations.

In accordance with an example embodiment of the present invention, it is furthermore provided that an abortion of the driving maneuver provides that the device for controlling the vehicle directly transfers the vehicle guidance to the driver. In the process, it is provided that no further control method intervenes between the highly automated driving maneuver and the transfer of the control of the driver, which could delay the transfer of the control.

In accordance with an example embodiment of the present invention, it may furthermore be provided that a termination of the vehicle maneuver provides that the vehicle is independently stopped and, upon reaching the standstill, the device for controlling the vehicle transfers the vehicle guidance to the driver. In this embodiment, the highly automated driving maneuver is terminated, however the vehicle control is not directly transferred to the operator of the remote control in the form of the portable unit, but first a process is carried out by which the vehicle is stopped until it is at a standstill, for example in a controlled manner. In the process, it provides that this transfer of the vehicle into the standstill takes place preferably quickly and takes place on a path movement which offers preferably little hazard potential.

The difference between the abortion of the driving maneuver and the termination of the driving maneuver is that, in the case of the abortion, the driving maneuver interrupts the vehicle guidance preferably quickly, and transfers the control over the vehicle to the vehicle driver or vehicle occupant. In the case of a termination of the driving maneuver, a stopping maneuver is initiated preferably quickly, the stopping maneuver transferring the vehicle preferably quickly into a safe state, for example a standstill, or avoiding a collision by a steering movement. In this way, a termination of the driving maneuver is not a direct transfer of the vehicle guidance to a vehicle driver or vehicle occupant, but this takes place indirectly by interposing the stopping maneuver.

In accordance with an example embodiment of the present invention, it is furthermore advantageous that the portable unit being dropped is detected by the portable unit in that a fall sensor is provided, whose signal is evaluated. In the process, fall sensors shall be understood to mean any type of sensor system which is able to detect a free fall. The evaluation of multiple sensors whose signals together detect and carry out a plausibility check of a free fall of the portable unit may also be provided as a fall sensor. In the process, possible fall sensors are particularly advantageous acceleration sensors which, for example, are able to detect accelerations in different directions of the portable unit, so [that] a resulting acceleration, for example in the magnitude of the gravitational force of the earth, may be established with the free fall. In addition or as an alternative, it is furthermore possible that the fall sensor is formed by a camera of the portable unit, which may, in particular, be a camera of a smart phone. In the process, in particular, the camera on the display side of the portable unit may be used, which is often referred to as a “selfie” camera and is able to record and evaluate the head or the face of the present operator. In the process, the detection of a fall may be implemented in that the camera of the portable unit detects the face or the head of the present operator, and this head or the face rapidly disappears from the camera detection field the moment the portable unit is dropped.

Furthermore, in accordance with example embodiments of the present invention, methods are provided, which relate to the implementation of the example method(s) according to the present invention in the portable unit or in the device for controlling.

The method may, for example, be implemented in software or hardware or in a mixed form made up of software and hardware, for example in a control device or a portable unit. The approach described here furthermore creates a control unit for a highly automated vehicle which is designed to carry out, activate or implement the steps of one variant of the method described here in corresponding devices.

The control unit for the highly automated vehicle or the portable unit may include an electrical device including at least one processing unit for processing signals or data, at least one memory unit for storing signals or data, and at least one interface and/or one communication interface for reading in or outputting data, which are embedded into a communication protocol. The processing unit may be a signal processor, for example, a so-called system ASIC or a microcontroller for processing sensor signals and outputting data signals as a function of the sensor signals. The memory unit may, for example, be a Flash memory, an EPROM or a magnetic memory unit. The interface may be designed as a sensor interface for reading in the sensor signals from a sensor and/or as an actuator interface for outputting the data signals and/or control signals to an actuator. The communication interface may be designed to read in or output the data wirelessly and/or hard-wired. The interfaces may also be software modules which are present on a microcontroller, for example, alongside other software modules.

In addition, a computer program product or computer program is advantageous, having program code which may be stored on a machine-readable carrier or memory medium such as a semiconductor memory, a hard disk memory or an optical memory, and which is used to carry out, implement and/or activate the steps of the method according to one of the specific embodiments described above, in particular if the program product or program is executed on a computer, a programmable control device or a similar device.

It is pointed out that several of the possible features and advantages of the present invention are described herein with reference to different specific embodiments as methods for controlling a vehicle, in particular, a highly automated vehicle. Those skilled in the art will recognize that the features may be suitably combined, adapted or exchanged to arrive at further specific embodiments of the present invention.

### BRIEF DESCRIPTION OF THE DRAWINGS

Exemplary embodiments of the present invention are described hereafter based on the figures.

FIG. 1a and FIG. 1b show two schematic illustrations for explaining the device according to the present invention and the method, according to example embodiments.

FIG. 2a and FIG. 2b show two schematic block diagrams for explaining different specific embodiments of the device according to example embodiments of the present invention.

FIG. 3 shows a schematic flowchart for explaining the method according to an example embodiment of the present invention.

### DETAILED DESCRIPTION OF EXAMPLE EMBODIMENTS

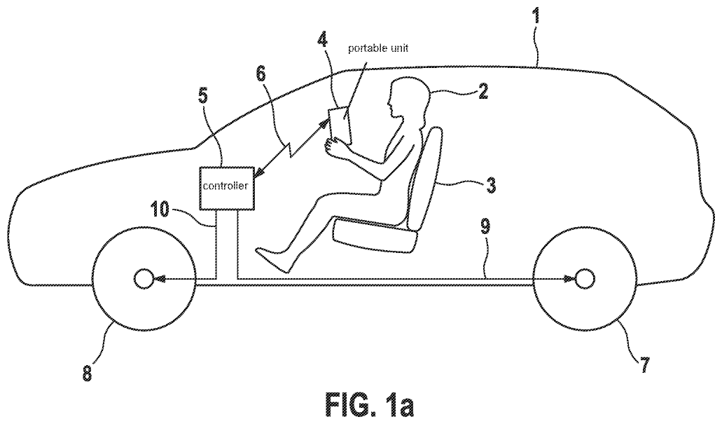

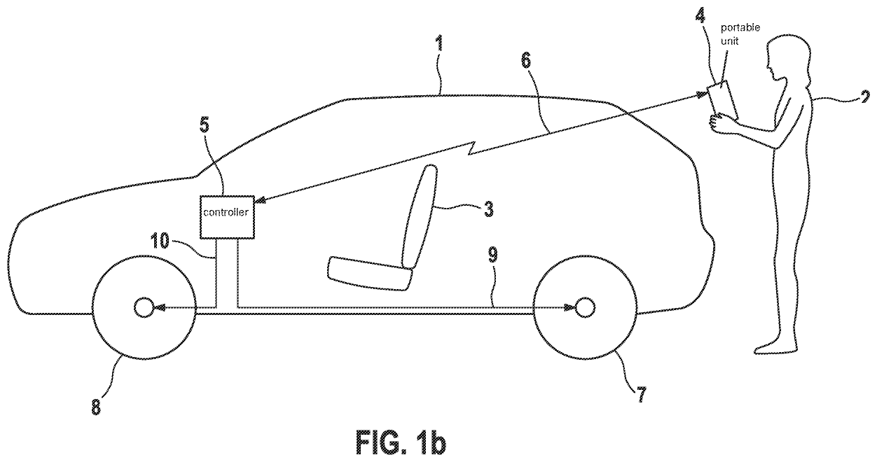

FIG. 1a shows a vehicle 1 which is, in particular, configured as a vehicle 1 driving in a highly automated manner. This highly automated vehicle is able to independently carry out driving maneuvers, or even to autonomously cover routes, without the driver or an occupant of vehicle 1 having to decisively intervene in the driving process. Furthermore, a vehicle driver 2 or a vehicle occupant 2 is shown inside vehicle 1 in FIG. 1a, who is sitting on vehicle seat 3 and is transported by vehicle 1 to a destination. In the process, vehicle driver 2 or vehicle occupant 2 is holding a portable unit 4 in his or her hand. This portable unit 4 may particularly advantageously be configured as a smart phone or tablet computer and serve as remote control or control unit for vehicle 1. Vehicle 1 is furthermore configured with the aid of a device for controlling 5 the vehicle, which receives signals from vehicle sensors, which are not shown, and outputs output signals 9, 10 to vehicle wheels 7, 8. It is shown by way of example in the process that output signal 9 of the device for controlling 5 acts on rear wheels 7 and in the process, in particular, controls or regulates a longitudinal vehicle control, i.e., output signal 9 controls the acceleration or deceleration of vehicle 1. Output signal 10 of the device for controlling 5 acts on front wheels 8 of vehicle 1 and, in the process, causes a steering of vehicle 1 in that signal 10 controls steering angles. The illustrated specific embodiment may also, of course, be configured for front wheel drive or all-wheel drive vehicles. It is to be noted here as essential for the invention that the device for controlling 5 outputs output signals 9, 10, with the aid of which the vehicle is controlled with respect to its longitudinal driving vehicle dynamics and with respect to its lateral vehicle dynamics. The device for controlling 5 is connected to portable unit 4 in the process, so that these two devices are able to exchange signals with one another. This connection 6 between portable unit 4 and the device for controlling 5 may be designed as an electrical cable; however, advantageously, it may also be configured as a radio link, and in particular may be configured as a radio link having a short range. In the process, it provides for the use of radio links having the Bluetooth standard or WLAN/WIFI standard or other available connection standards.

FIG. 1b, in turn, shows vehicle 1, as was already described in FIG. 1a. This vehicle 1, in turn, includes a vehicle seat 3 inside. The shown vehicle driver 2, however, is not inside vehicle 1 in FIG. 1b, but is situated outside vehicle 1 for the present driving maneuver, which may be a parking maneuver, for example. Vehicle driver 2 is holding portable unit 4 in his or her hands, which is connected to the device for controlling 5 the vehicle with the aid of a connection 6, which may, in particular, be configured as a radio link 6. The device for controlling 5, in turn, outputs signals 9, 10, which act on front wheels 8 or rear wheels 7 of the vehicle, and are able to steer and control vehicle 1 with respect to its longitudinal vehicle dynamics and/or its lateral vehicle dynamics.

Vehicle 1, as it is shown in FIGS. 1a and 1b, carries out independent driving maneuvers with the aid of the device for controlling 5 to transport vehicle 1 to destinations predefined by occupants 2 or vehicle driver 2. This destination may, for example, also be the parking of vehicle 1 in a parking spot. In the process, vehicle driver 2 or vehicle occupant 2 may monitor vehicle 1 in its present driving maneuver, and during certain driving maneuvers it may be necessary that vehicle driver 2 or vehicle occupants 2 must effectuate an immediate stop of vehicle 1, or must effectuate an immediate termination of the presently carried out vehicle maneuver, to avoid a hazard, for example a collision. Vehicle driver 2 or vehicle occupant 2 may implement this with the aid of portable unit 4.

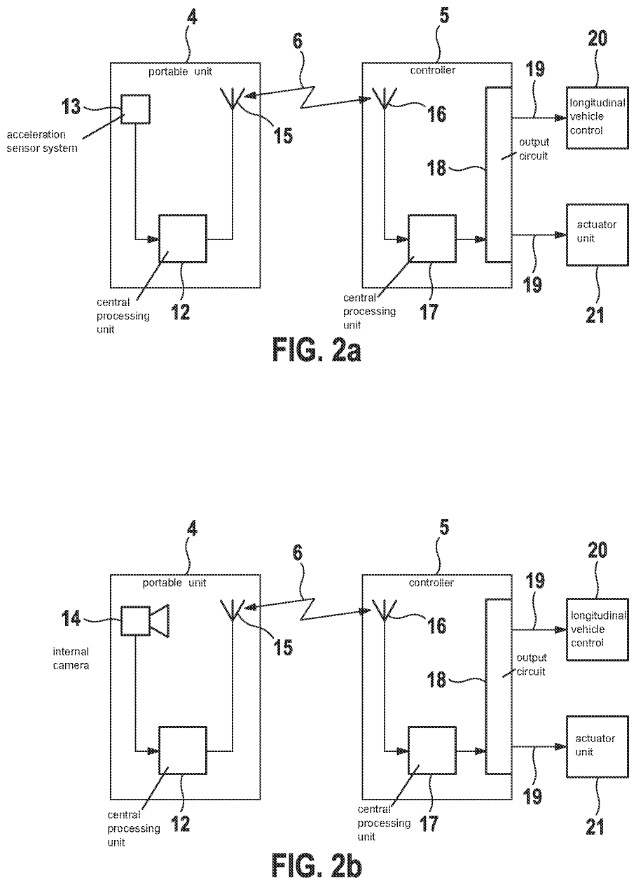

FIG. 2a shows a schematic block diagram of portable unit 4 as well as of the device for controlling 5. Portable unit 4 includes a central processing unit 12 as one of its integral components, which may, for example, be configured as a microcontroller or microprocessor and on which applications (“apps”) may run for a wide variety of usage purposes of portable unit 4. Portable unit 4 furthermore includes a fall sensor as one of its integral components, which is able to detect a free fall of portable unit 4. This fall sensor is designed as acceleration sensor system 13 in the exemplary embodiment of FIG. 2, which is able to detect accelerations of portable unit 4 in different directions. This may, for example, be implemented with the aid of inertia sensors designed as an inertial sensor system. This acceleration sensor system 13 may calculate an overall-resulting acceleration of portable unit 4 and detect when this overall acceleration approximately corresponds to the magnitude of the gravitational force of the earth. In this case, acceleration sensor system 13, supported by processing unit 12, may detect a free fall of portable unit 4. Processing unit 12 is furthermore connected to an antenna 15 of portable unit 4, via which portable unit 4 is able to exchange signals with other devices, for example with the aid of the device for controlling 5. If a free fall was detected by acceleration sensor system 13, processing unit 12 may transmit corresponding signals via antenna 15, which signal that a free fall was detected. In this case, an accordingly encoded signal is emitted via radio link 6 to the device for controlling 5, which, in turn, includes an antenna 16 with the aid of which the fall signal may be received. This antenna 16 of the device for controlling 5 is connected, by way of example, with the aid of a central processing unit 17 in which, by way of example, also the presently carried out driving maneuver of vehicle 1 is controlled and checked. In this way, input signals from surroundings sensor systems of vehicle 1 may furthermore be supplied to the device for controlling 5, which was not illustrated in FIG. 2a for the sake of simplification. Based on these signals as well as navigation data and additional supplied signals, the device for controlling 5 may output output signals 19 via an output circuit 18 to downstream units. These downstream units may, for example, be actuator units for longitudinal vehicle control 20, with the aid of which the acceleration and the deceleration of vehicle 1 is controlled and regulated. Furthermore, an actuator unit 21 for the lateral vehicle control may be provided as downstream devices, with the aid of which vehicle 1 may carry out steering movements. When a fall signal is supplied to central processing unit 17 via antenna 16, the device for controlling 5 recognizes that the present driving maneuver is to be directly aborted or terminated, and corresponding output signals 19 are to be output. In the case of an abortion of the presently carried out driving maneuver, output signals 19 to downstream actuator units 20, 21 are immediately deactivated. In the case of a termination of the presently carried out driving maneuver, output signals 19 may be output to downstream actuator units 20, 21, so that vehicle 1 may be transferred preferably quickly and preferably safely into a safe state, in particular, into the vehicle standstill.

FIG. 2b shows an exemplary embodiment very similar to that described in FIG. 2a. The majority of components shown and described in FIG. 2a are identically designed in FIG. 2b. In contrast, the fall sensor is designed differently, which in the exemplary embodiment according to FIG. 2b is not designed as an acceleration sensor system, but as an internal camera 14 of portable unit 4. In the event that portable unit 4 is designed as a smart phone, it is possible to use the camera present on the display side of the smart phone as an installed camera, which is often also referred to as a “selfie” camera. This selfie camera 14 may record the face or the head of vehicle driver 2 or of vehicle occupant 2 and may detect portable unit 4 being dropped in that the detected head or the detected face disappears very quickly from the camera field of view. Furthermore, it is possible that this internal camera 14 of portable unit 4 authenticates the present user of the vehicle and of portable unit 4, for example in that biometric facial features or biometric eye features are identified with the aid of camera 14, and a remote control of vehicle 1 with the aid of portable unit 4 is only possible when the present vehicle driver or present vehicle occupant 2 has the necessary remote control rights for vehicle 1, for example because he or she previously authenticated himself or herself on the portable unit.

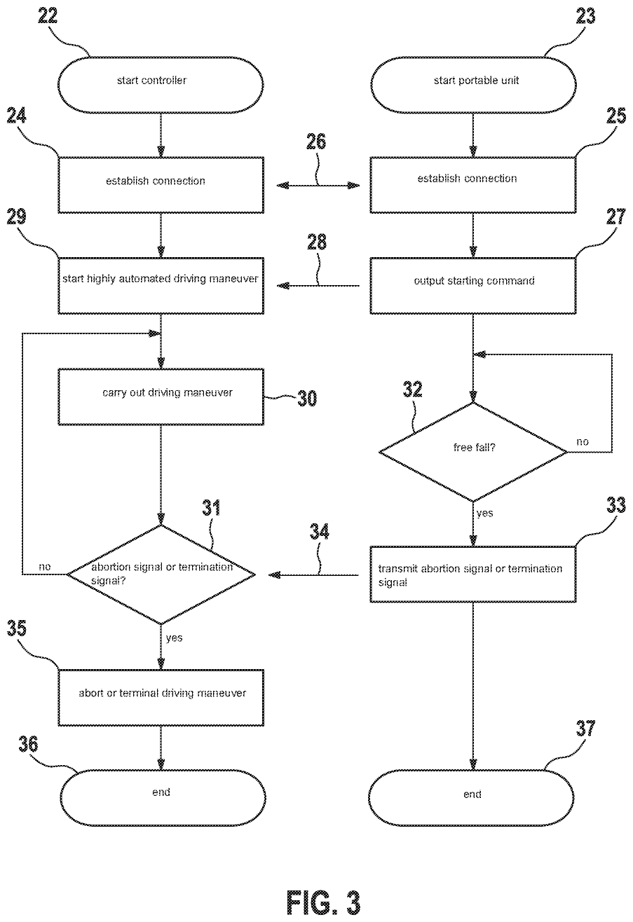

FIG. 3 shows an exemplary flowchart, with the aid of which the method according to the present invention as well as the cooperation of the methods according to the present invention of portable unit 4 and of the device for controlling 5 are explained. In step 22, for example, the device for controlling 5 is started and put into operation. In step 23 taking place in parallel, portable unit 4 is also started and put into operation. The device for controlling 5 thereupon starts step 24 by establishing the connection. Also, step 25 is started in portable unit 4, which also includes an establishment of the connection to the device for controlling 5, and a shared transmission 26 of signals is established. These signals 26 establish connection 6, which may, in particular, be designed as a radio link. In further step 29, a highly automated driving maneuver is started by the device for controlling 5. This may, for example, be a trip to a driving destination entered by one of vehicle occupants 2. As an alternative, it is also possible that a parking maneuver into a parking space situated in the vicinity of the vehicle is started as the driving maneuver. After the connection has been successfully established in step 25, portable unit 4 may output (step 27) a starting command for a driving maneuver in that vehicle driver 2 or vehicle occupant 2 selects and deliberately starts a corresponding driving maneuver. This starting command is transmitted with the aid of a transmitted start signal 28 to the device for controlling 5 vehicle 1, whereupon in step 29 the highly automated driving maneuver is started. Thereupon, the subsequently shown step 30 follows in the device for controlling 5, in which the driving maneuver is carried out. In the process, a loop is run through during the execution of the driving maneuver in that it is repeatedly queried in step 31 whether an abortion signal or a termination signal was received. As long as no such abortion signal or termination signal is received by the device for controlling 5, step 31 branches off toward “No” and is continued in step 30 in that the driving maneuver continues to be carried out. In parallel thereto, it is continuously checked in portable unit 4 whether according to step 32 a free fall was detected. This may take place, for example, with the aid of an acceleration sensor system 13 or with the aid of a camera in portable unit 4. If a free fall of portable unit 4 was not detected in step 32, the method is continued in step 32 as a loop until the driving maneuver is completed. If, prior to the end of the driving maneuver, a free fall is detected by portable unit 4, step 32 branches off toward “Yes,” and in subsequent step 33, an abortion signal or a termination signal 34 is transmitted from portable unit 4 to the device for controlling 5. When this abortion signal or termination signal 34 is received by the device for controlling 5, step 31 branches off in the device for controlling 5 toward “Yes,” and in subsequent step 35, the driving maneuver is aborted or terminated, depending on the design of the method according to the present invention in the particular vehicle 1. Within the scope of step 35, the vehicle guidance is immediately transferred to vehicle driver 2 or vehicle occupant 2, or also the vehicle is transferred preferably quickly into a safe state with the aid of a termination maneuver. If the vehicle guidance was transferred to vehicle driver 2 or to vehicle occupant 2, or vehicle 1 was transferred into the standstill, the device for controlling 5 in step 36 ends its methods and awaits a renewed activation. After the emission of abortion signal or termination signal 34, portable unit 4 in step 33 may also end the corresponding method in step 37.

What is claimed is:

1. A device for controlling a highly automated vehicle, the highly automated vehicle independently carrying out driving maneuvers without an intervention of a driver or a vehicle occupant, the device configured to:
connect to a portable unit;
receive a signal from the portable unit that the portable unit has detected a dropping of the portable unit by the vehicle driver or a vehicle occupant; and
upon detection of a free fall, abort or terminate a presently independently carried out driving maneuver.

2. A portable unit for remotely controlling a highly automated vehicle, the highly automated vehicle independently carrying out driving maneuvers without an intervention of a driver or a vehicle occupant, the portable configured to:
connect to a device for controlling the highly automated vehicle; and
supply a signal to the device for controlling that the portable unit has detected a dropping of the portable unit by a vehicle driver or a vehicle occupant;
wherein, upon detection of a free fall, a presently independently carried out driving maneuver is aborted or terminated.

3. The device as recited in claim 1, wherein a connection between the device and the portable device is a wireless connection.

4. The device as recited in claim 3, wherein the wireless connection is a radio link having a short range.

5. The portable unit as recited in claim 2, wherein the portable unit is a smart phone or a tablet computer.

6. The portable unit as recited in claim 2, wherein the portable unit is a remote control for controlling the driving maneuver of the highly automated vehicle.

7. The device as recited in claim 1, wherein the abortion of the driving maneuver provides that the device for controlling the vehicle directly transfers vehicle guidance to the driver.

8. The device as recited in claim 1, wherein the termination of the vehicle maneuver provides that the vehicle is automatically stopped, and the device for controlling the vehicle transfers vehicle guidance to the driver only when a standstill of the vehicle has been reached.

9. The portable unit as recited claim 2, wherein the portable unit includes a fall sensor, and wherein the portable unit being dropped is detected by the portable unit by the fall sensor whose signal is evaluated.

10. The portable unit as recited in claim 9, wherein the fall sensor is an acceleration sensor system.

11. The portable unit as recited in claim 9, wherein the fall sensor is a camera of the portable unit on a display side of the portable unit.

12. The device as recited in claim 11, wherein the fall sensor is implemented in that the camera of the portable unit detects the dropping when a previously detected face of the vehicle driver or of the vehicle occupant suddenly disappears from a detection area of the camera.

13. A method for controlling a highly automated vehicle, the highly automated vehicle independently carrying out driving maneuvers without an intervention of a driver or a vehicle occupant, the method comprising:
connecting a device for controlling the vehicle to a portable unit;
receiving, by the device for controlling, a signal from the portable unit when the portable unit has detected a dropping by the vehicle driver or a vehicle occupant; and
upon receipt of the signal, aborting or terminating a presently independently carried out driving maneuver.

14. A method of a portable unit for remotely controlling a highly automated vehicle, the highly automated vehicle independently carrying out driving maneuvers without the intervention of a driver or a vehicle occupant, the method comprising:
connecting the portable unit to a device for controlling the highly automated vehicle;
supplying, by the portable unit, a signal to the device for controlling when the portable unit has detected a dropping by the vehicle driver or the vehicle occupant;
wherein, upon detection of a free fall, a driving maneuver presently independently carried out by the device for controlling the vehicle is aborted or terminated.
